(19) United States
(12) Patent Application Publication
(10) Pub. No.: US 2024/0218914 A1
(43) Pub. Date: Jul. 4, 2024

(54) BUNGEE CORD SECURING DEVICE

(71) Applicant: Richard Gregg, Tulare, CA (US)

(72) Inventor: Richard Gregg, Tulare, CA (US)

(21) Appl. No.: 12/506,141

(22) Filed: Jul. 20, 2009

Related U.S. Application Data
(60) Provisional application No. 61/082,023, filed on Jul. 18, 2008.

(51) Int. Cl. F16G 11/10

(52) U.S. Cl. CPC F16G 11/106

(57) ABSTRACT

A bungee cord securing device comprising a block housing containing a clamping device, and a method for securing cargo using the bungee cord securing device and a pull cylinder. A single bungee cord is folded so that the folded bungee cord passes through an opening in the securing device. The two ends of the bungee cord is capped with a pull cylinder adjacent to the securing device. The loop formed by folding the bungee cord is wrapped around cargo and the portion of the bungee cord on which the securing device and pull cylinder are located is inserted through the loop to secure cargo. To tighten the loop, the securing device is pushed away from the pull cylinder. A cam-wheel located inside the block housing is rotated to clamp the bungee cord. The excess portion is looped back into the bungee cord with the pull cylinder to avoid dangling.

### CROSS-REFERENCE TO RELATED APPLICATION

This application claims the benefit of the priority filing date of provisional patent application No. 61/082,023 filed on Jul. 18, 2008.

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention generally relates to securing or fastening mechanisms, and more specifically to a device for adjusting the length of an elastic cord, also known as a bungee cord.

The object of the current invention is to allow the length of a cord, particularly, a bungee cord to be temporarily adjusted to suit a particular application, thus avoiding the need for various bungee cord lengths.

Several devices for adjusting the length of a bungee cord exist the art. For example, in U.S. Pat. No. 6,049,950 to Cavallo, the device comprises at least two separate sections of bungee cord. One cord section is firmly attached to a locking device, while the other cord section is adjustable using the locking device which comprises a latch hook and lip.

In U.S. Pat. No. 5,987,707 to DeShon, a device consisting of a T-shaped housing with three openings is used to secure bungee cords to a specific length. A bungee cord passes through two of the openings, while the third opening allows the excess length of a bungee cord to be pulled through to form a loop. Tapered grooves in the third hole allow the loop section of bungee cord to be held in place by virtue of friction.

In U.S. Pat. No. 5,802,679 to Neeley, a circular cleat utilizes the friction of teeth between two walls of the cleat to hold the bungee cord in place. The device can be adapted to comprise a hook member thus allowing the length of bungee cord to be adjusted.

The prior art for adjusting a bungee cord length is cumbersome, difficult to operate, and minimally effective. It is therefore the object of the present invention to facilitate the adjustment of an elastic cord length without making permanent changes to the length of the cord. Adjusting the length of an elastic cord, and consequently its tension, allows a single elastic cord to be used in numerous applications.

The problem of temporarily adjusting the length of a cord, particularly a bungee cord, to suit a particular application in a simple manner is solved by a bungee cord securing device comprising a block housing containing a clamping device, such as a cam-wheel. A single bungee cord is folded so that the folded bungee cord passes through an opening in a block housing. The two ends of the bungee cord is capped with a pull cylinder and the single bungee cord now forms a loop. Both the block housing and the pull cylinder are situated closest to the ends of the folded bungee cord, closing the loop. To secure cargo, the loop wraps around the cargo (e.g., wood panels) and the other end of the bungee cord that is capped with a pull cylinder is inserted through the loop until both the pull cylinder and the block housing passes through the loop. The block housing is pushed away from the pull cylinder until it secures the cargo in place. To clamp the bungee cord, a cam-wheel inside the block housing is rotated in one direction until the opening in the block housing closes. The portion of bungee cord between the block housing and the pull cylinder is excess portion, which can be looped back into the bungee cord using the pull cylinder so that it does not dangle. The bungee cord can be released from the clamp, by rotating the cam-wheel in the opposite direction until the openings in the block housing are wide enough to release the bungee cord.

### SUMMARY

The present invention generally relates to securing or fastening mechanisms, and more specifically to a device for adjusting the length of an elastic cord, also known as a bungee cord.

It is the object of the present invention to facilitate the adjustment of an elastic cord length without making permanent changes to the length of the cord (e.g., cutting it). Adjusting the length of an elastic cord, and consequently its tension, allows a single elastic cord to be used in numerous applications.

The problem of temporarily adjusting a bungee cord length to suit a particular application in a simple manner is solved by a bungee cord securing device comprising a block housing containing a clamping device, such as a cam-wheel. A single bungee cord is folded so that the folded bungee cord passes through an opening in a block housing. The two ends of the bungee cord is capped with a pull cylinder and the single bungee cord now forms a loop. Both the block housing and the pull cylinder are situated closest to the ends of the folded bungee cord, closing the loop. To secure cargo, the loop wraps around the cargo (e.g., wood panels) and the other end of the bungee cord that is capped with a pull cylinder is inserted through the loop until both the pull cylinder and the block housing passes through the loop. The block housing is pushed away from the pull cylinder until it secures the cargo in place. To clamp the bungee cord, a cam-wheel inside the block housing is rotated in one direction until the opening in the block housing closes. The portion of bungee cord between the block housing and the pull cylinder is excess portion, which can be looped back into the bungee cord using the pull cylinder so that it does not dangle. The bungee cord can be released from the clamp, by rotating the cam-wheel in the opposite direction until the openings in the block housing are wide enough to release the bungee cord.

This and other objects of the present invention will become apparent when considered in view of the ensuing detailed description and drawings.

### FIGURES

FIG. 1 is a perspective view of the invention, illustrating the manner in which the device will be used with a bungee cord.

FIG. 2 is a perspective view of a preferred embodiment of the invention.

FIG. 3 is a cross-sectional view through line B-B of FIG. 6 of the bungee cord securing device showing the slot for a bungee cord section to be pulled through.

FIG. 4 is a cross-sectional view through line A-A of FIG. 4 of the bungee cord securing device with the cam-wheel in the open position.

FIG. 5 is a rear view of the bungee cord securing device.

FIG. 6 is a right side view of the bungee cord securing device with the cam-wheel in the open position.

FIG. 7 is a cross-sectional view through line C-C of FIG. 5.

FIGS. 8-10 are perspective views of members of the housing.

FIG. 11 is a perspective view of a preferred embodiment of the cam-wheel.

FIG. 12 is a perspective view of a pull cylinder with a large and small opening.

FIG. 13 is a perspective view of the invention, illustrating a section of lumber being secured to a vehicle cargo rack using both the bungee cord securing device and the pull cylinder.

### DESCRIPTION

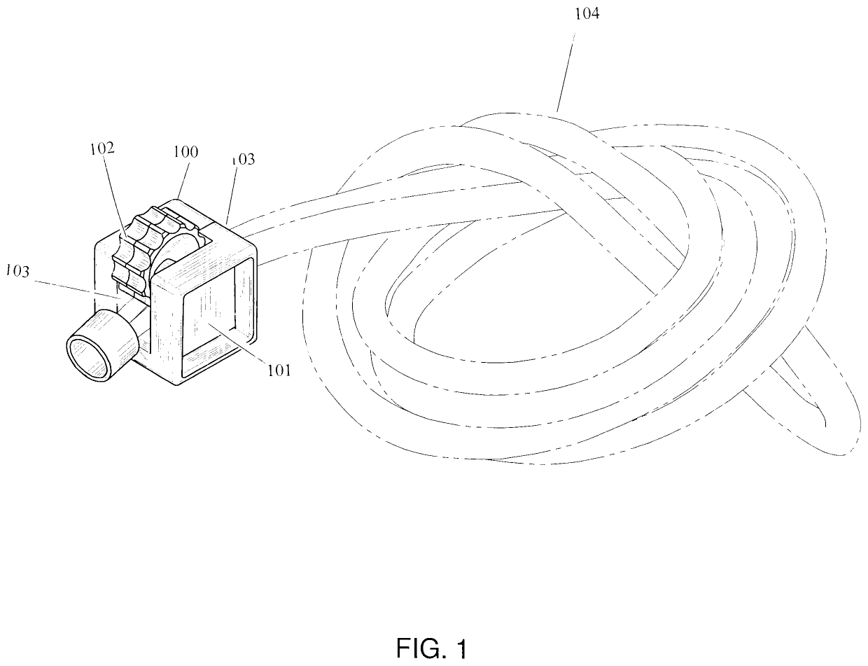

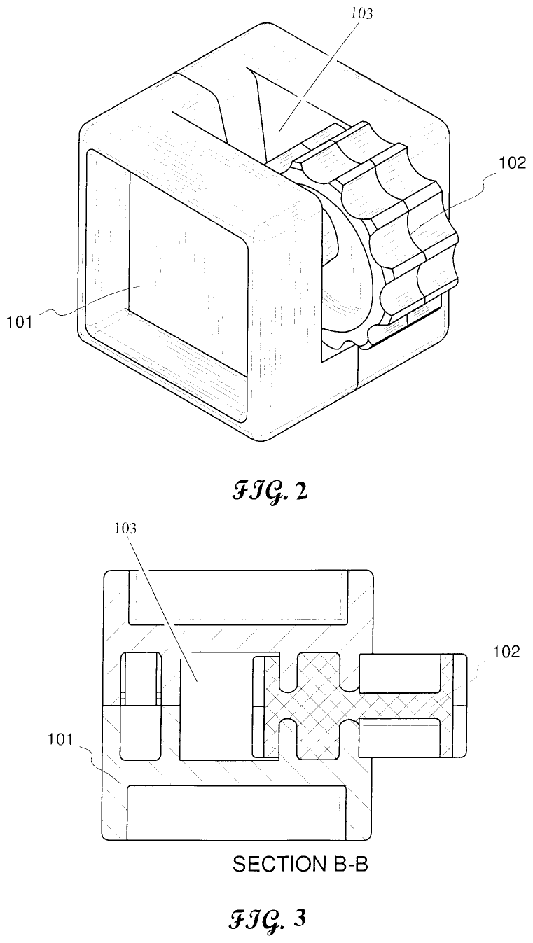

Referring to FIGS. 1-4, the bungee cord securing device 100 comprises a block housing 101 and a rotatable cam-wheel 102 affixed within the block housing.

Still referring to FIGS. 1-4, the block housing 101 comprises two openings 103 through which two ends of a bungee cord 104 (or a looped bungee cord) can pass.

Referring to FIG. 2, the bungee cord securing device 100 is shown in the open position, i.e., the cam-wheel 102 has not been rotated in the direction that closes the two openings 103. In this position, two ends of a bungee cord 104 (or a looped bungee cord) may pass through the block housing 101.

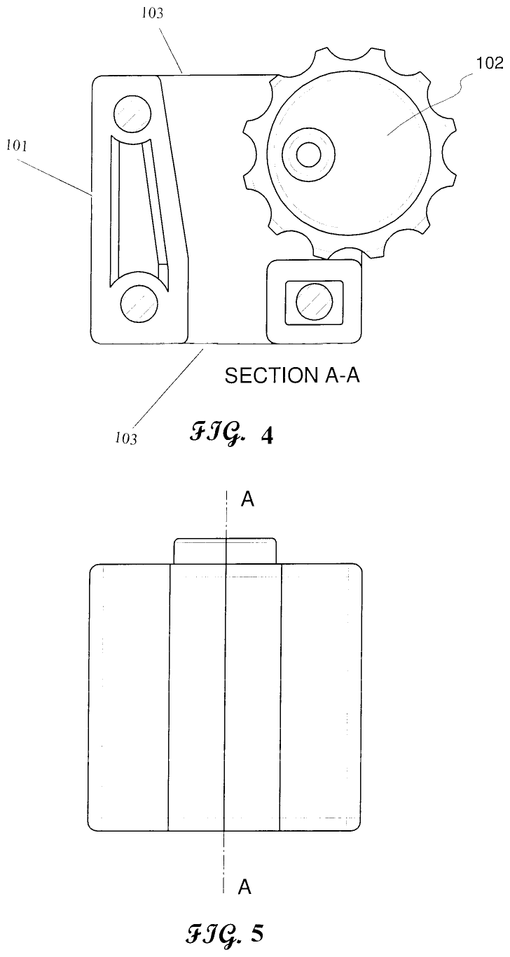

Referring to FIG. 4, the cam-wheel 102 is shown with its center of rotation away from its horizontal axis. Here, the bungee cord securing device 100 is in an open position, allowing two ends of a bungee cord 104 (or a looped bungee cord) to pass between the cam-wheel 102 and the block housing 101. Once the cam-wheel 102 is rotated in one direction, the cam-wheel 102 shifts closer to the center of the block housing 101 (i.e., the closed position). This narrows the two openings 103 and fastens the bungee cord 104 in place. To release the bungee cord 104 from the cam-wheel 102, the cam-wheel 102 is rotated in the opposite direction, thereby broadening the two openings 103 and allowing the bungee cord 104 to slide through.

FIG. 5 is a rear view of the bungee cord securing device 100.

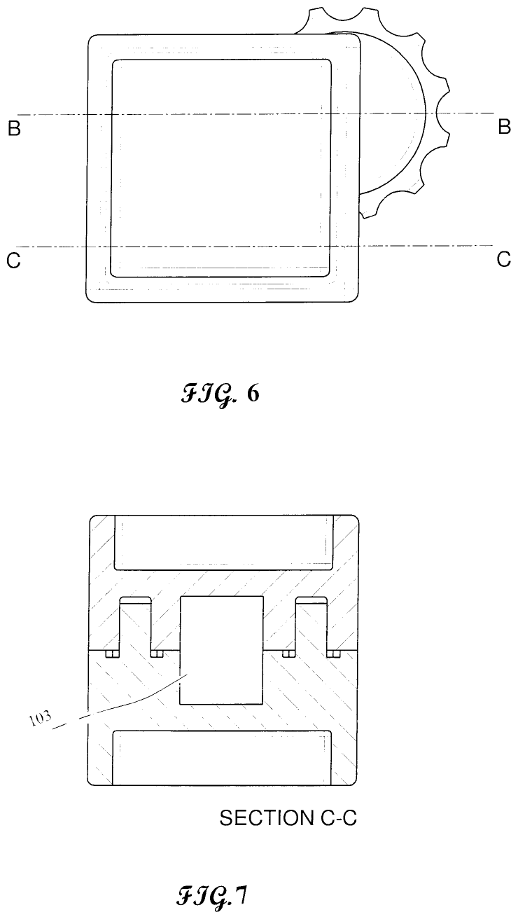

FIG. 6 is a right side view of the bungee cord securing device 100 with the cam-wheel 102 in the open position.

FIG. 7 is a cross-sectional view of the bungee cord securing device 100 through line C-C of FIG. 6.

Referring to FIG. 7, section C-C of FIG. 6 shows one of the two openings 103 through which two ends of a bungee cord 104 (or a looped bungee cord) may pass.

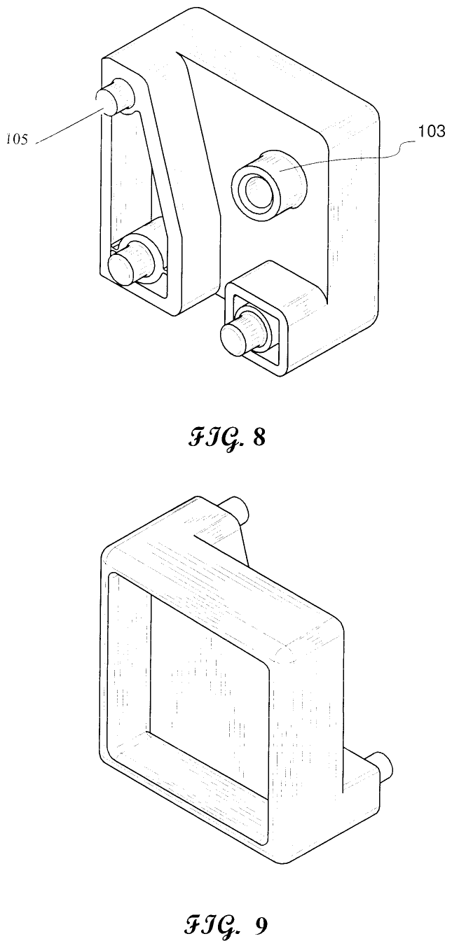

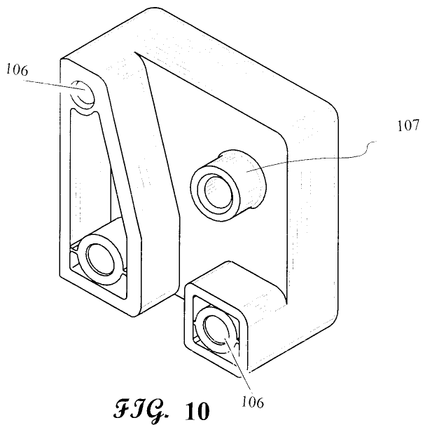

Referring to FIGS. 8 through 10, the housing 101 is comprised of a left member and a right member, with one having male protrusions 105 and the other having female protrusions 106 to allow the two members to be joined together. Both members comprise a cavity 107 to allow the cam-wheel 102 to be affixed and to rotate freely when mounted in the block housing 101.

FIG. 11, is a perspective view of a preferred embodiment of the cam-wheel 102 comprising a cam-wheel protrusion 108 that is inserted into the cavity 107 of the two members of the block housing 101.

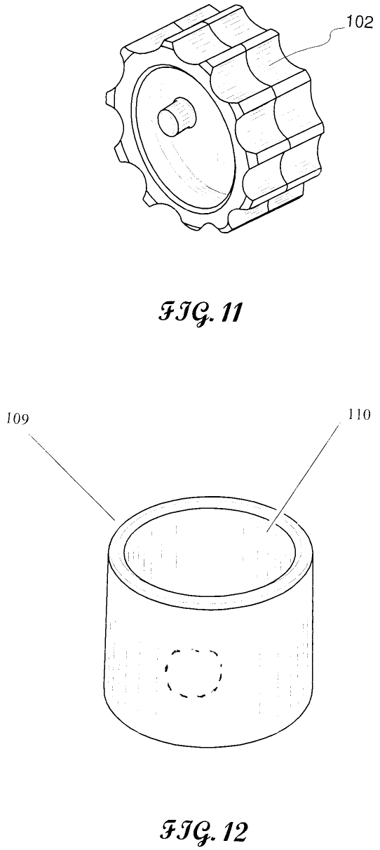

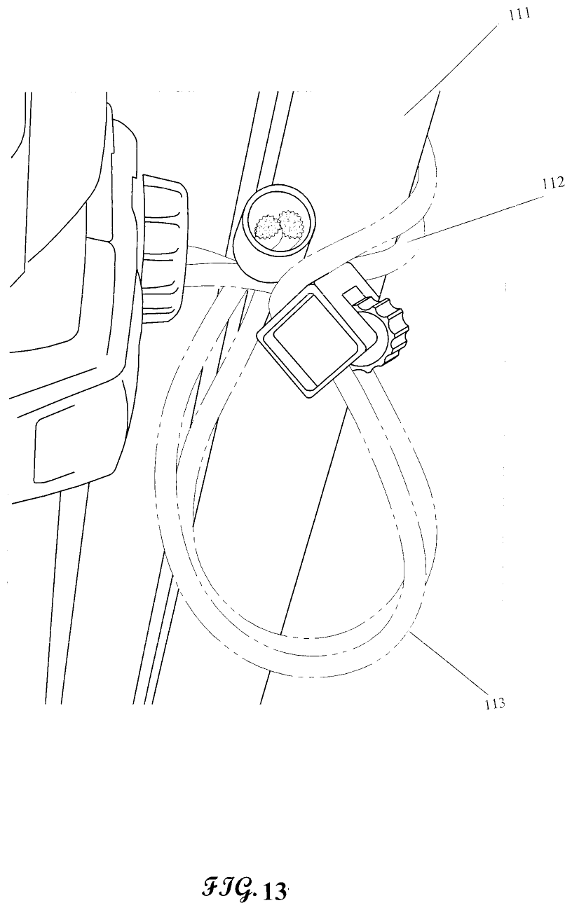

FIG. 12 is a perspective view of a pull cylinder 109 comprised of a large opening 109 and a small opening 110. The bungee cord passes through the small opening 110.

FIG. 13 shows how the pull cylinder 109 is used in conjunction with the bungee cord securing device 100. First, the bungee cord 104 is folded so that a loop is formed and the two ends of the bungee cord 104 are positioned together. Both the bungee cord securing device 100 and the pull cylinder 109 are positioned at the two ends of the bungee cord 104, closing the loop. The pull cylinder 109 is situated closest to the two ends. The looped bungee cord 104 is wrapped around cargo 111. To secure the cargo 111, the two ends of the bungee cord 104, including the pull cylinder 109 and the bungee cord securing device 100, are inserted through the far end of the loop 112. This portion of the folded bungee cord 104 is the excess portion 103 that is normally cut off. Instead of cutting the excess portion 103, the bungee cord securing device 100 is pushed away from the pull cylinder 109 until the cargo 111 is held tightly in place. To clamp the bungee cord so that the bungee cord securing device 100 stays in place and the bungee cord 104 does not loosen, the cam-wheels are rotated in one direction, so that the two openings 103 in the block housing 101 are narrowed, and until the bungee cord is clamped. Furthermore, the block shape of the bungee cord securing device makes it difficult for it to slip out of the loop. Next, the excess portion 103 is inserted back into the looped bungee cord 104 using the pull cylinder 109 so that the excess portion 103 does not dangle.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. § 112, paragraph 6. In particular, the use of “step of” in the claims herein is not intended to invoke the provisions of 35 U.S.C. § 112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. A cord securing device for securing cargo, comprising:
a. a housing comprising a clamping means, and
b. at least one opening, through which at least one cord, including a bungee cord, is inserted

2. The housing of claim 1, wherein the housing is in the shape of a block;

3. The housing of claim 2, wherein housing comprises two members with male and female joining parts;

4. The two members of claim 3, wherein each member comprises an attachment for a clamping means,

5. The clamping means of claim 1, wherein the clamping means is a rotatable cam-wheel.

6. The rotatable cam-wheel of claim 5, wherein its center of rotation is away from its horizontal axis.

7. The rotatable cam-wheel of claim 5, wherein rotation in one direction narrows the at least one opening of claim 1 and rotation in the opposite direction broadens the at least one opening of claim 1.

8. The at least one opening of claim 1, wherein the opening is of sufficient size to accommodate a folded bungee cord.

9. A cord securing device for securing cargo, comprising:
a. a housing comprising a clamping means;
b. at least one opening, through which at least one cord, including a bungee cord, is inserted; and
c. a pull cylinder for managing excess cord.

10. The housing of claim 9, wherein the housing is in the shape of a block;

11. The housing of claim 10, wherein housing comprises two members with male and female joining parts;

12. The two members of claim 11, wherein each member comprises an attachment for a clamping means,

13. The clamping means of claim 9, wherein the clamping means is a rotatable cam-wheel.

14. The rotatable cam-wheel of claim 13, wherein its center of rotation is away from its horizontal axis.

15. The rotatable cam-wheel of claim 13, wherein rotation in one direction narrows the at least one opening of claim 9 and rotation in the opposite direction broadens the at least one opening of claim 9.

16. The at least one opening of claim 9, wherein the opening is of sufficient size to accommodate a folded bungee cord.

17. The pull cylinder of claim 9, wherein at least one end of the pull cylinder comprises an opening of sufficient size to accommodate two ends of a bungee cord.

18. A method of securing a cord, including a bungee cord, comprising the steps of:
(a) folding a cord so that a loop is formed and the two ends of the cord are positioned adjacent to each other;
(b) inserting both ends of the cord through an opening in a cord securing device featuring a clamping means;
(c) capping the ends of the cord with a pull cylinder;
(d) positioning both the cord securing device featuring a clamping means adjacent to the pull cylinder;
(e) wrapping the loop around cargo;
(f) in regards to the portion of the cord on which the pull cylinder and cord securing device featuring a clamping means is situated, inserting that portion of the chord through the loop so that both the pull cylinder and cord securing device featuring a clamping means pass through the loop;
(g) tightening the loop by moving the cord securing device featuring a clamping means along the cord and away from the pull cylinder;
(h) clamping the cord using the clamping means of the cord securing device;
(i) securing the excess cord between the pull cylinder and the cord securing device featuring a clamping means by inserting the pull cylinder back through the loop.

19. The method of claim 18, in which the cord securing device is in the shape of a block.

20. The method of claim 18, in which the clamping means is a rotatable cam-wheel.
